(19) United States
(12) Patent Application Publication
(10) Pub. No.: US 2009/0300877 A1
(43) Pub. Date: Dec. 10, 2009

(54) DEVICE AND METHOD OF MECHANICALLY DAMPENING A HOLD OPEN ROD

(76) Inventors: Matthew J. WOOD, Waco, TX (US); Del E. Latham, Crawford, TX (US); Gary McMurtrey, China Spring, TX (US)

Correspondence Address: BAKER & HOSTETLER LLP, WASHINGTON SQUARE, SUITE 1100, 1050 CONNECTICUT AVE. N.W., WASHINGTON, DC, 20036-5304, US

(21) Appl. No.: 12/135,778

(22) Filed: Jun. 9, 2008

(51) Int. Cl. E05F 1/00

(52) U.S. Cl. 16/71

(57) ABSTRACT

A mechanical rate control device for mechanically dampening a telescoping hold open rod including an outer tube, an inner tube concentrically displaced within the outer tube. The inner tube includes a head portion and at least two friction pads surrounding the inner tube. Each of the at least two friction pads includes an internal surface which substantially complements an external surface of the inner tube.

### FIELD OF THE INVENTION

The present invention relates generally to a method and device for dampening a hold open apparatus. More particularly, the present invention relates to the use of concentric friction pads within a tube to extend and retract the components of a hold open rod with a desired rate of restriction.

### BACKGROUND OF THE INVENTION

Door closers are used to close a door after being opened manually or automatically. Generally, door closers include a cylinder having a piston connected to a piston rod within the cylinder. The piston is normally biased by a compression spring. The opposed ends of the cylinder and the piston rod may be suitably connected between a door frame and its door. The opening of the door causes the piston to be rectilinearly displaced within the inner surface of the cylinder whereby the connected piston rod is extended beyond the end of the cylinder, thereby compressing the spring. The compression spring, acting on the piston in its compressed state, normally functions to return the door to its closed position as the door is released after the opening of the door.

In certain applications, the door closers may include dampened hold open rods that may be used to control the rate at which a door closes. To control the closing of a door, pneumatic springs or hydraulic-type dampeners have been used to dampen the movement of hold open rods. The retracting momentum of the piston is typically cushioned by compression of fluid, such as air or oil inside the cylinder tube to create a damping resistance opposite the force that propels the door to close for better control of the speed and force at which the door closes.

A known problem regarding currently used dampeners is that the fluid used in these devices introduces an opportunity for undesirable leakage. In addition, these hydraulics and pneumatics have seals, wipers and o-rings that wear and require frequent maintenance and replacement.

Accordingly, an improved rate controlling device is desired that will achieve dampening through mechanical means.

### SUMMARY OF THE INVENTION

The foregoing needs are met, to a great extent, by the present invention, wherein in one aspect an apparatus is provided that, in some embodiments, mechanically controls the components of a hold open rod to extend and retract with a desired rate of restriction.

In accordance with one embodiment of the present invention, a mechanical rate control device mechanically dampens a telescoping hold open rod. The device includes an outer tube, an inner tube concentrically displaced within the outer tube, wherein the inner tube includes a head portion and at least two friction pads surrounding the inner tube, wherein each of the at least two friction pads includes an internal surface which substantially complements an external surface of the inner tube. Accordingly, a transverse load is produced from an axial force resulting from extending and contracting the hold open rod.

In some embodiments, the head portion and/or the friction pads are tapered or fresto-conical such that an end of the head portion pushes more firmly against the friction pads. Also, to enable flexibility in the design and manufacture of the hold open rod, the head portion may be threadedly attached to the inner tube.

In accordance with example embodiments of the present invention, the device may include seals between the friction pads and inner tube which act as springs to push the friction pads away from the external surface of the inner tube. The seals may further include flange portions which aid the compression of the friction pads. In some embodiments, the friction pads are made of an elastomeric material. In certain applications of the invention, a first end of the device is hingedly attached to a door and a second end of the device is hingedly attached to a door frame.

In accordance with other embodiments of the present invention, a mechanical rate control device which mechanically dampens a telescoping hold open rod, includes an outer tube, an inner tube concentrically displaced within the outer tube, wherein the inner tube includes a head portion, friction means for dampening the movement of the inner tube, wherein each of the friction means substantially complements the inner tube to produce the desired rate of restriction. Accordingly, a transverse load is produced from an axial force resulting from extending and contracting the hold open rod.

In example embodiments of the invention, a method of mechanically dampening a telescoping hold open rod includes: telescoping an outer tube with respect to an inner tube, wherein the inner tube includes a head portion and dampens the movement of the inner tube by driving the inner tube axially along at least two friction pads, wherein each of the at least two friction pads substantially complements the inner tube to produce the desired rate of restriction. Accordingly, a transverse load is produced from an axial force resulting from extending and contracting the hold open rod.

There has thus been outlined, rather broadly, certain embodiments of the invention in order that the detailed description thereof herein may be better understood, and in order that the present contribution to the art may be better appreciated. There are, of course, additional embodiments of the invention that will be described below and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of embodiments in addition to those described and of being practiced and carried out in various ways. Also, it is to be understood that the phraseology and terminology employed herein, as well as the abstract, are for the purpose of description and should not be regarded as limiting.

As such, those skilled in the art will appreciate that the conception upon which this disclosure is based may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

FIG. 1 is a cross-sectional view illustrating a mechanical dampening device according to a preferred embodiment of the invention.

FIG. 2 is a partially cutaway view of the mechanical dampening device shown in FIG. 1.

FIG. 3 is a plan view also displaying the cross-section of the mechanical dampening device shown in FIG. 1.

### DETAILED DESCRIPTION

The invention will now be described with reference to the drawing figures, in which like reference numerals refer to like parts throughout. An embodiment in accordance with the present invention provides a mechanical dampening device having two friction pads driven transversely along an inner surface of the tube of a hold open rod. In example embodiments, the mechanical dampener enables the extension and retraction of the components of the hold open rod at a desired rate of restriction without the disadvantages of hydraulic dampening.

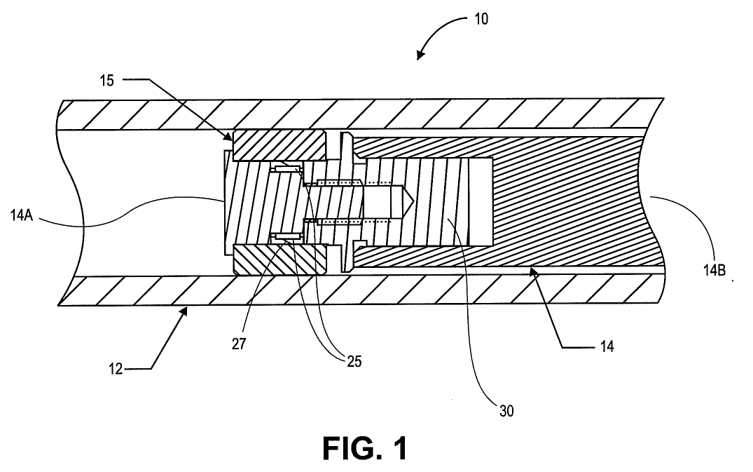

An embodiment of the inventive dampening apparatus is illustrated in FIG. 1. In example embodiments of the invention, a hold open rod 10 is made of two or more concentric tubes: an outer tube 12 and an inner tube 14. The hold open rod 10 includes friction pads 15 along the inner surfaces of the outer tube 12 and contouring the outer surfaces of the inner tube 14. In example embodiments, the friction pads 14 are fixedly attached to the outer tube 12. When the hold open rod 10 is in use, the friction pads 14 are pushed by the inner tube 14 firmly against the inner walls of the outer tube 12.

In example embodiments, the hold open rod 10 has a proximate end 14A and a distal end 14B. The inner tube 14 may also include a head 20 which is angled such that the head 20 pushes more firmly against the friction pads 15 at the proximate end 14A of the inner tube 14. The head 20 may be tapered or fresto-conical shaped. The friction pads 15 may also be tapered or fresto-conical shaped. Additionally, the hold open rod 10 may include seals 25 having raised flange portions 27 which push against the narrower portions of the head 20. As such, the seals 25 push the friction pads 15 away from the external surface of the inner tube 14.

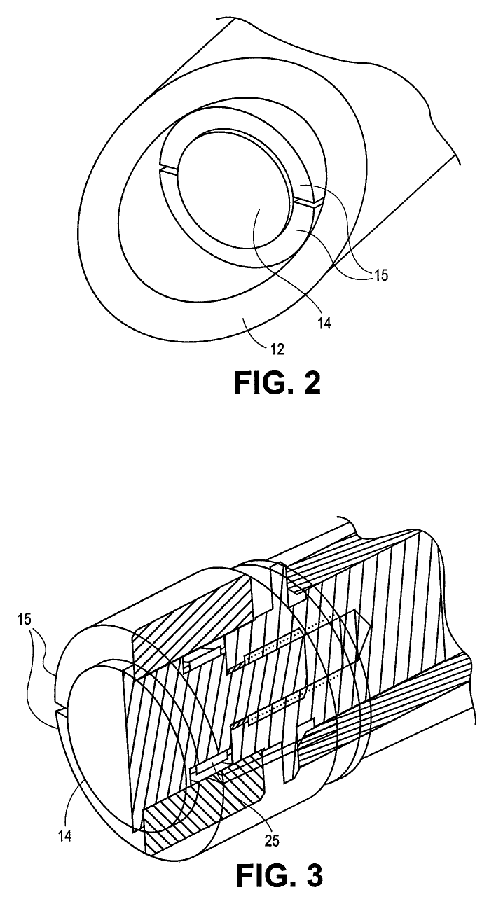

FIG. 2 is a partially cutaway view of the hold open rod 10 shown in FIG. 1. In example embodiments of the invention, the friction pads 15 may include two complimentary halves which encase the outer surface of the inner tube 14, as best shown in the partial cutaway view of FIG. 2. In certain applications, the dampening device may be used to control the rate at which a door (not shown) opens or closes. The hold open rod 10 may be attached at either the proximate 14A or distal 14B ends of the hold open rod 10.

In example embodiments, the distal end 14B is attached to the door, while the proximate end 14A is attached to a door housing (i.e. the door frame) or the wall adjacent to the door housing. As understood by one of ordinary skill in the art, attachments between the hold open rod 10 and a door and door frame should be hinged to allow pivoting of the attachment. This may be accomplished, for example, by using a hinge and bracket.

In example embodiments of the invention, the head 20 of the inner tube 14 may be removably or threadedly attached to the tube 14 via a threaded insert 30, as shown in FIG. 1. This allows for the head 20 and the threaded insert to be made from a different material than the inner tube 14. In some embodiments, a portion of the inner tube 14 may be hollow. This enables the manufacturing and maintenance of the hold open rod 10 to be cost efficient. In other embodiments, however, the inner tube 12 may be one solid piece of material.

When the door is opened or closed, the inner tube 14 moves with respect to the outer tube 12 in a telescoping manner. As the tubes move axially, compression of the friction pads 15 provide friction between the pads 15 and inner tube 14 outer wall, thereby creating a dampening to slow the movement of the telescoping tubes. The friction pads 15 are driven transversely along the outer surface of the inner tube 14. A transverse load is then produced from an axial force resulting from the extending and retracting of the hold open rod 10. In the example embodiment where the head 20 of the inner tube 14 is tapered inward, the friction pads 15 are more firmly pushed into the inner wall of the outer tube 12 as the slope of the head 20 increases. The flange portions, which protrude from the seals 25, act as springs to further push the friction pads 14 against the inner wall of the outer tube 12.

FIG. 3 is a plan view also displaying the cross-section of the mechanical dampening device shown in FIG. 1. The shape and material of the friction pads 15 and tube head 20 control the coefficient of friction and therefore, control the dampening feature of the hold open rod 10. The friction pads may be shaped to complement the outer surface of the head 20 such that the desired dampening occurs. As appreciated by one of ordinary skill in the art, the friction pads 15 may be made of an elastomeric material, such as ethylene vinyl acetate, for example.

In example embodiments of the invention, a method of mechanically dampening a telescoping hold open rod 10 includes: telescoping an outer tube 12 with respect to an inner tube 14, wherein the inner tube 14 includes a head portion 20 and dampens the movement of the inner tube 14 by driving the inner tube 14 axially along friction pads 15. Each of the friction pads 15 generally complements the inner tube 14 to produce the desired rate of restriction. Accordingly, a transverse load is produced from an axial force resulting from extending and contracting the hold open rod 10.

The many features and advantages of the invention are apparent from the detailed specification, and thus, it is intended by the appended claims to cover all such features and advantages of the invention which fall within the true spirit and scope of the invention. Further, since numerous modifications and variations will readily occur to those skilled in the art, it is not desired to limit the invention to the exact construction and operation illustrated and described, and accordingly, all suitable modifications and equivalents may be resorted to, falling within the scope of the invention.

What is claimed is:

1. A mechanical rate control device for mechanically dampening a telescoping hold open rod, comprising:
an outer tube;
an inner tube concentrically displaced within the outer tube, wherein the inner tube includes a head portion; and,
at least two friction pads surrounding the inner tube, wherein each of the at least two friction pads includes an internal surface which substantially complements an external surface of the inner tube;
wherein a transverse load is produced from an axial force resulting from extending and contracting the hold open rod.

2. The mechanical rate control device of claim 1, wherein the head portion comprises a tapered portion.

3. The mechanical rate control device of claim 1, wherein the head portion comprises a fresto-conical portion.

4. The mechanical rate control device of claim 1, further comprising a seal between the friction pads and inner tube.

5. The mechanical rate control device of claim 4, wherein the seal acts as a spring to push the friction pads away from the external surface of the inner tube.

6. The mechanical rate control device of claim 4, wherein the seal further comprises a flange portion.

7. The mechanical rate control device of claim 1, wherein the head portion is threadedly attached to the inner tube.

8. The mechanical rate control device of claim 1, wherein the friction pads comprise an elastomeric material.

9. The mechanical rate control device of claim 1, wherein a first end of the device is hingedly attached to a door.

10. The mechanical rate control device of claim 9, wherein a second end of the device is hingedly attached to a door frame.

11. The mechanical rate control device of claim 1, wherein the at least two friction pads comprise a tapered portion.

12. The mechanical rate control device of claim 1, wherein the at least two friction pads comprise a fresto-conical portion.

13. A mechanical rate control device for mechanically dampening a telescoping hold open rod, comprising:
an outer tube;
an inner tube concentrically displaced within the outer tube, wherein the inner tube includes a head portion; and
friction means for dampening the movement of the inner tube, wherein each of the friction means substantially complements the inner tube to produce a desired rate of restriction;
wherein a transverse load is produced from an axial force resulting from extending and contracting the hold open rod.

14. A method of mechanically dampening a telescoping hold open rod, comprising:
telescoping an outer tube with respect to an inner tube, wherein the inner tube includes a head portion;
dampening the movement of the inner tube by driving the inner tube axially along at least two friction pads, wherein each of the at least two friction pads substantially complements the inner tube to produce the desired rate of restriction;
wherein a transverse load is produced from an axial force resulting from extending and contracting the hold open rod.
